(19) United States
(12) Patent Application Publication
(10) Pub. No.: US 2022/0234325 A1
(43) Pub. Date: Jul. 28, 2022

(54) GUIDES FOR FOLDED PORTIONS OF INFLATABLE WEBS

(71) Applicant: Sealed Air Corporation (US), Charlotte, NC (US)

(72) Inventors: Michael Andrew Clarke, Gastonia, NC (US); Garrett P. Dyer, Charlotte, NC (US); Yunji Gu, Charlotte, NC (US); Bradley K. Powell, Rock Hill, SC (US)

(21) Appl. No.: 17/609,838

(22) PCT Filed: May 8, 2020
(86) PCT No.: PCT/US2020/031991

§ 371 Date: Nov. 9, 2021

Related U.S. Application Data
(60) Provisional application No. 62/845,350, filed on May 9, 2019.

(51) Int. Cl. B31D 5/00

(52) U.S. Cl. CPC B31D 5/0073; B31D 2205/0082; B31D 2205/0047

(57) ABSTRACT

A guide can be used to improve inflatability of web material. The guide can be in a system that also includes a supply of a web material and an inflation and sealing system. The web material includes chambers that are in fluid communication with a common channel. The web material in the supply is folded about a longitudinal fold such that lengths of the chambers are folded. The inflation and sealing system is configured to inflate and seal the chambers as the web material is fed from the supply. The guide has a guide mechanism configured to be located between portions of the web material as the web material is being fed from the supply. The guide mechanism is configured to at least partially unfold the longitudinal fold in the web material at a point in the system where the inflation and sealing system is configured to inflate the chambers.

### BACKGROUND

The present disclosure is in the technical field of automated formation of inflated packages. More particularly, the present disclosure is directed to guides for use with folded portions of inflatable web material that improve the inflatability of the web material.

Consumers frequently purchase goods from mail-order or internet retailers, which package and ship the goods to the purchasing consumer via a postal service or other carrier. Millions of such packages are shipped each day. These items are normally packaged in small containers, such as boxes or envelopes. To protect the items during shipment, they are typically packaged with some form of protective dunnage that may be wrapped around the item or stuffed into the container to prevent movement of the item and to protect it from shock.

Common types of mailing envelope are sometimes referred to as “mailers.” In some cases, these mailers have cushioning to provide some level of protection for the objects transported therein. The outer walls of cushioned mailers are typically formed from protective materials, such as Kraft paper, cardstock, polyethylene-coated paper, other paper-based materials, polyethylene film, or other resilient materials. The inner walls of cushioned mailers are lined with cushioning materials, such as air cellular material (e.g., BUBBLE WRAP™ air cellular material sold by Sealed Air Corporation), foam sheets, or any other cushioning material. The outer walls are typically adhered (e.g., laminated) to the cushioning material when forming the mailers.

When goods are shipped in rigid containers, such as corrugated cardboard boxes, dunnage material is typically added to the containers to take up some of the void space within the containers. Inflated cushions, pillows, or other inflated containers are common void fill materials that are either placed loose in a container with an object or wrapped around an object that is then placed in a container. The cushions protect the packaged item by absorbing impacts that may otherwise be fully transmitted to the packaged item during transit, and also restrict movement of the packaged item within the carton to further reduce the likelihood of damage to the item. Another common form of void fill material is paper, such as Kraft paper, that has been folded or crumped into a low-density, three-dimensional pad or wad that is capable of filling void space without adding significant weight to the container.

It would be advantageous to automate the packaging process to minimize the amount of time required to package objects properly. However, given the wide variety of ways which objects can be packaged for shipping, automation of the packaging process can be challenging.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In a first embodiment, a system includes a supply of a web material, an inflation and sealing system, and a guide. The web material includes chambers that are in fluid communication with a common channel. The web material in the supply is folded about a longitudinal fold such that lengths of the chambers are folded. The inflation and sealing system is configured to inflate and seal the chambers as the web material is fed from the supply. The guide has a guide mechanism that is configured to be located between portions of the web material as the web material is being fed from the supply. The guide mechanism is configured to at least partially unfold the longitudinal fold in the web material at a point in the system where the inflation and sealing system is configured to inflate the chambers.

In a second embodiment, the guide mechanism of the first embodiment includes rollers configured to contact the web material on either side of the longitudinal fold.

In a third embodiment, the rollers of the second embodiment are idle rollers configured to rotate from contact with the web material as the web material moves.

In a fourth embodiment, wherein the rollers of any of the second to third embodiments are driven such that the rollers impart a force to the web material as the rollers rotate.

In a fifth embodiment, the guide mechanism of any of the previous embodiments further comprises a guide structure configured to support the guide mechanism between sides of the folded web material.

In a sixth embodiment, the guide structure of the fifth embodiment includes a first end and a second end. The guide mechanism is coupled to the second end.

The guide mechanism is coupled to the guide structure such that the guide mechanism is configured to be located at one of a number of different locations with respect to the first end.

In a seventh embodiment, the system of the sixth embodiment is configured such that the guide structure comprises upper leg segments and lower leg segments and the upper leg segments and the lower leg segments are coupled to each other so that the guide mechanism capable of being located at the number of different locations with respect to the first end.

In an eighth embodiment, the guide of any of the fifth to seventh embodiments further comprises a power transmission system configured to couple a driving force to the guide mechanism in order to drive the guide mechanism.

In a ninth embodiment, the system of the eighth embodiment is further configured such that the guide structure includes an upper cross piece and a lower cross piece, the power transmission system includes a driveshaft that passes through the upper and lower cross pieces, and the power transmission system includes a first gear coupled to a first end of the driveshaft above the upper cross piece and a second gear coupled to a second end of the driveshaft below the lower cross piece.

In a tenth embodiment, 10. the system of the ninth embodiment is further configured such that the guide mechanism includes rollers coupled to a spindle and the spindle includes a third gear configured to engage the second gear such that rotation of the first gear causes rotation of the driveshaft, the second gear, the third gear, the spindle, and the rollers.

In an eleventh embodiment, the guide of the tenth embodiment is configured to be located in the system such that at least a portion of the first gear is located above the web material.

In a twelfth embodiment, the rollers of any of the tenth to eleventh embodiments are in contact with the web material so that rotation of the rollers imparts a force on the web material.

In a thirteenth embodiment, the force imparted by the rollers of the twelfth embodiment has a substantially similar magnitude to a second force imparted on the web material by the inflation and sealing system.

In a fourteenth embodiment, the power transmission system of the thirteenth embodiment is coupled to a driving force that also drives the inflation and sealing system such that the rollers apply the force applied by the rollers at substantially any time that the inflation and sealing system applies the second force.

In a fifteenth embodiment, the guide mechanism of any of the previous embodiments contacts the web material to cause the web material to have a U-shaped cross-section at the point in the system where the inflation and sealing system is configured to inflate the chambers.

In a sixteenth embodiment, the guide is located in the system downstream of the inflation and sealing system such that the guide mechanism contacts the web material at a location other than the point in the system where the inflation and sealing system is configured to inflate the chambers.

In a seventeenth embodiment, the guide of any of the previous embodiments is a static guide and the guide mechanism is a static guide mechanism.

In an eighteenth embodiment, the static guide mechanism of the seventeenth embodiment includes a foot that has a contoured shape.

In a nineteenth embodiment, the foot of the eighteenth embodiment has a front end and a back end, and wherein the front end is narrower than the back end.

In a twentieth embodiment, the guide of any of the seventeenth to nineteenth embodiments further comprises a guide structure configured to support the guide mechanism between sides of the folded web material, and wherein the guide mechanism is coupled to the guide structure by a biasing mechanism.

In a twenty first embodiment, a guide is usable with an inflatable web material. The web material includes chambers that are in fluid communication with a common channel. The web material in a supply of the web material is folded about a longitudinal fold such that lengths of the chambers are folded. The guide includes a guide structure and a guide mechanism supported by the guide structure. The guide mechanism is configured to be located between portions of the web material as the web material is being fed from the supply. The guide mechanism is configured to at least partially unfold the longitudinal fold in the web material at a point where the inflation and sealing system is configured to inflate the chambers. The guide mechanism is configured to contact the web material to cause the web material to have a U-shaped cross-section.

In a twenty second embodiment, the guide of the twenty first embodiment is position able with respect to the inflation and sealing system to cause the web material to have the U-shaped cross-section at the point where the inflation and sealing system is configured to inflate the chambers.

In a twenty third embodiment, the guide mechanism of any of the twenty first to twenty second embodiments includes one or more of a belt, a slider mechanism, a bearing, or a continuous track.

In a twenty fourth embodiment, the guide of any of the twenty first to twenty third embodiments further includes a power transmission system configured to couple a driving force to the guide mechanism in order to drive the guide mechanism.

In a twenty fifth embodiment, the guide mechanism of any of the twenty first to twenty fourth embodiments is a static guide mechanism.

In a twenty sixth embodiment, the static guide mechanism of the twenty fifth embodiment includes a foot that has a contoured shape.

In a twenty seventh embodiment, the guide mechanism of any of the twenty first to twenty sixth embodiments is coupled to the guide structure by a biasing mechanism.

### BRIEF DESCRIPTION OF THE DRAWING

The foregoing aspects and many of the attendant advantages of the disclosed subject matter will become more readily appreciated as the same become better understood by reference to the following detailed description, when taken in conjunction with the accompanying drawings, wherein:

FIG. 1A depicts an example of a web material that can be formed into a pouch for packaging an object, in accordance with the embodiments disclosed herein;

FIGS. 1B and 1C depict front and side cross-sectional views, respectively, of an embodiment of the web material shown in FIG. 1A in a folded state before inflation of the chambers, in accordance with the embodiments disclosed herein;

FIG. 2A depicts a top view of a portion of an embodiment of an automated packaging station that includes a supply of the web material shown in FIGS. 1B and 1C, in accordance with the embodiments disclosed herein;

FIG. 2B depicts a cross-sectional view of the web material 100 as it is held by the automated packaging station shown in FIG. 2A for inflation and sealing of the chambers, in accordance with the embodiments disclosed herein;

FIGS. 3A and 3B depict perspective and front views, respectively, of an embodiment of a guide that can be positioned inside of the web material to improve inflatability of the web material, in accordance with the embodiments disclosed herein;

FIG. 4A depicts a top view of an embodiment of the guide shown in FIGS. 3A and 3B located in a portion of the automated packaging station shown in FIG. 2A, in accordance with the embodiments disclosed herein;

FIG. 4B depicts a cross-sectional view of the web material as it is held in FIG. 4A by the automated packaging station and the guide for inflation and sealing of the chambers, in accordance with the embodiments disclosed herein;

Depicted in FIG. 5 is a side view of an example of improper feeding of the web material that can result from the use of a guide with idle rollers;

FIGS. 6A and 6B depict perspective and partial front views, respectively, of an embodiment of a driven guide that can be positioned inside of the web material to improve inflatability of the web material while avoiding skewing of the web material, in accordance with the embodiments disclosed herein;

FIG. 7A depicts a top view of an embodiment of the driven guide shown in FIGS. 6A and 6B located in a portion of the automated packaging station shown in FIG. 2A, in accordance with the embodiments disclosed herein;

FIG. 7B depicts a cross-sectional view of the web material as it is held in FIG. 7A by the automated packaging station and the driven guide for inflation and sealing of the chambers, in accordance with the embodiments disclosed herein;

FIG. 7C depicts a side view of an example of proper feeding of the web material that can result from the use of the driven guide in the position shown in FIGS. 7A and 7B, in accordance with the embodiments disclosed herein;

FIGS. 8A, 8B, and 8C depict perspective, front, and side views, respectively, of an embodiment of a static guide that can be positioned inside of the web material to improve inflatability of the web material, in accordance with the embodiments disclosed herein;

FIG. 9A depicts a top view of an embodiment of the guide shown in FIGS. 8A to 8C located in a portion of the automated packaging station shown in FIG. 2A, in accordance with the embodiments disclosed herein; and

FIG. 9B depicts a cross-sectional view of the web material as it is held in FIG. 9A by the automated packaging station and the guide for inflation and sealing of the chambers, in accordance with the embodiments disclosed herein.

### DETAILED DESCRIPTION

The present disclosure describes embodiments of guides that can be used to improve inflatability of web material. In some embodiments, a guide can be located in a system that also includes a supply of a web material and an inflation and sealing system. The web material includes chambers that are in fluid communication with a common channel. The web material in the supply is folded about a longitudinal fold such that lengths of the chambers are folded. The inflation and sealing system is configured to inflate and seal the chambers as the web material is fed from the supply. The guide has a guide mechanism configured to be located between portions of the web material as the web material is being fed from the supply. The guide mechanism is configured to at least partially unfold the longitudinal fold in the web material at a point in the system where the inflation and sealing system is configured to inflate the chambers. Other variations and embodiments of guides are described in greater detail herein.

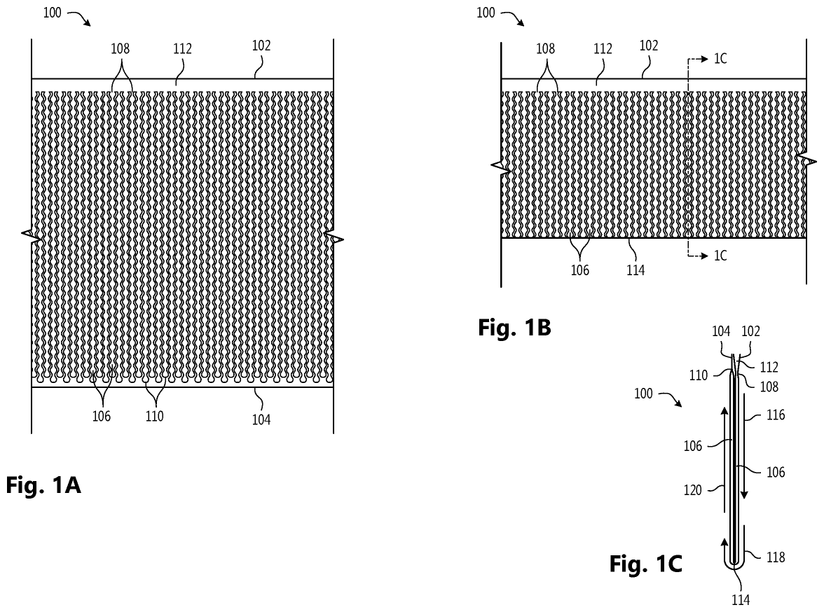

Depicted in FIG. 1A is an example of a web material 100 that can be formed into a pouch for packaging an object. In the depicted embodiment, the web material 100 is an inflatable air cellular material. As used herein, the term “air cellular material” herein refers to bubble cushioning material, such as BUBBLE WRAP® air cushioning material sold by Sealed Air Corporation, where a first film or laminate is formed (e.g., thermoformed, embossed, calendared, or otherwise processed) to define a plurality of cavities and a second film or laminate is adhered to the first film or laminate in order to close the cavities. Examples of air cellular materials are shown in U.S. Pat. Nos. 3,142,599, 3,208,898, 3,285,793, 3,508,992, 3,586,565, 3,616,155, 3,660,189, 4,181,548, 4,184,904, 4,415,398, 4,576,669, 4,579,516, 6,800,162, 6,982,113, 7,018,495, 7,165,375, 7,220,476, 7,223,461, 7,429,304, 7,721,781, and 7,950,433, and U.S. Published Patent Application Nos. 2014/0314978 and 2015/0075114, the disclosures of which are hereby incorporated by reference in their entirety.

As used herein, an “object” may comprise a single item for packaging or grouping of several distinct items where the grouping is to be in a single package. Further, an object may include an accompanying informational item, such as a packing slip, tracking code, a manifest, an invoice, or printed sheet comprising machine-readable information (e.g., a bar code) for sensing by an object reader (e.g., a bar code scanner). In some embodiments, each of the objects includes an object identifier. In some examples, the object identifier includes one or more of a barcode, a quick response (QR) code, a radio frequency identification (RFID) tag, any other form a machine-readable information, human-readable information, or any combination thereof.

The web material 100 includes a first longitudinal edge 102 and a second longitudinal edge 104. Between the first and second longitudinal edges 102 and 104 are two juxtaposed sheets (e.g., sheets of film) that are sealed together to form chambers 106. In the depicted embodiment, the chambers 106 are in an uninflated state and the chambers 106 are capable of being inflated. In the depicted embodiment, each of the chambers 106 extends substantially transversely across the web material 100 and the pattern of the chambers 106 generally repeats in the longitudinal direction.

In the depicted embodiment, each of the chambers 106 includes a port 108 that is open and a distal end 110 that is closed. The ports 108 are located proximate the first longitudinal edge 102 and the distal ends 110 are located proximate the second longitudinal edge 104 so that the ports extend substantially transversely across the web material 100. The juxtaposed sheets are sealed between the ports 108 and the distal ends 110 such that each of the chambers 106 has substantially circular cells that are interconnected by channels that are narrower than the widest point of the cells. The chambers 106 are capable of being inflated by inserting a gas (e.g., air) through the ports 108. Once the chambers 106 are inflated, the cells form three-dimensional shapes (sometimes referred to as “bubbles”) along the inflated chambers 106. In the depicted embodiment, a pair of adjacent chambers 106 are offset so that the cells of one of the chambers 106 are aligned with the interconnecting cells of a subsequent one of the chambers 106.

To aid in inflation of the chambers 106, the web material 100 includes a common channel 112. In the depicted embodiment, the common channel 112 is in fluid communication with the chambers 106. In some embodiments, a nozzle can be inserted in the common channel 112 and direct a gas into the common channel 112. The gas inserted into the common channel 112 can pass through the ports 108 to inflate the chambers 106. In some embodiments, the nozzle may remain fixed while located within the common channel 112 and the web material 100 is moved longitudinally such that the nozzle sequentially inflates the chambers 106. Coupled to the nozzle may be a sealing device configured to close (e.g., seal closed) the ports 108 after inflation of the chambers 106.

In some embodiments, the web material 100 can be folded and formed into a pouch for holding and cushioning an object. In some embodiments, the web material 100 can be folded, inflated, and transversely sealed to form an inflated pouch. An object can be inserted into the pouch and then the pouch can be closed to form a package around the object. Examples of systems and methods of forming a pouch and then a package in this manner are described in U.S. Patent Application No. 62/783,250, the contents of which are hereby incorporated by reference herein by reference in their entirety. In some embodiments, the web material 100 is formed from a material that is suitable for shipping the object. For example, the web material 100 may be opaque.

In order to form an inflated pouch, the web material 100 can be folded, inflated, and transversely sealed. Depicted in FIGS. 1B and 10 are front and side cross-sectional views, respectively, of an embodiment of the web material 100 in a folded state before inflation of the chambers 106. A longitudinal fold 114 has been formed in the web material 100. In the depicted embodiment, the longitudinal fold 114 is substantially in the middle of the web material 100 between the first and second longitudinal edges 102 and 104. This type of fold is sometimes referred to as a “C fold” because the first and second longitudinal edges 102 and 104 are substantially the same distance away from the longitudinal fold 114, as opposed to a “J fold” when a longitudinal fold is offset from the center of the web material so that the longitudinal edges extend different distances away from the longitudinal fold.

In the folded orientation shown in FIGS. 1B and 10, the web material 100 can be wound onto a supply roll. In some embodiments, the web material 100 can be wound such that the longitudinal ends 102 and 104 are on one side of the roll and the longitudinal fold 114 are on the other side of the roll. To inflate the web material 100, the web material 100 can be unwound from the roll and fed through an inflation and sealing system that inflates and seals the chambers 106 sequentially. In some embodiments, the inflation and sealing system includes a nozzle that can be positioned such that the two sides of the common channel 112 pass over the nozzle as the web material 100 is fed away from the supply roll. In the depicted embodiment, the common channel 112 is an “open” channel because the two sheets are not commented to each other. An open channel allows the two sheets to pass on either side of the nozzle without cutting the channel. In other embodiments, the common channel 112 can be a “closed” channel where the two sheets are connected to each other. A closed channel requires the two sheets to be cut before the sheets can pass on either side of the nozzle.

To inflate the chambers 106, the nozzle can insert gas into common channel 112 so that the gas passes through the ports 108 and into the chambers 106 in a substantially linear direction indicated by an arrow 116. As some of the gas reaches the longitudinal fold 114, the gas passes in the direction indicated by the arrow 116, then around the longitudinal fold 114 as indicated by an arrow 118, and then continues through the chambers 106 toward the distal ends 110 in a direction indicated by the arrow 120. The gas may fill both the portions of the chambers 106 between the longitudinal fold 114 and the distal ends 110 and the portions of the between the longitudinal fold 114 and the ports 108.

When the web material 100 is folded about the longitudinal fold 114 in the configuration shown in FIGS. 1B and 10, the chambers 106 may not consistently inflate properly. As can be seen in FIG. 10, the longitudinal fold 114 can function as a crease in the web material 100 which deters or prevents gas from passing through the chambers 106 at the longitudinal fold 114. In this case, during the time that one of the chambers 106 is exposed to the gas from the nozzle, the longitudinal fold 114 may prevent sufficient gas from passing through the longitudinal fold 114 to fully inflate the chamber. The chambers 106 can thus be under inflated and not provide a desired amount of cushioning. In addition, the arrows 116 and 120 are substantially parallel to each other and in substantially opposite directions. When the gas is inserted into the chambers in the direction indicated by the arrow 116, the sides of the chambers 106 near the longitudinal fold 114 operate to change the direction of the flow of gas. The forces imparted by the gas as it changed directions may be sufficient to cause deformity (e.g., stretching) or failure (e.g., rupture) of the walls of the chambers 106 near the longitudinal fold 114. In the case of deformity of the chambers 106, the resulting package can be aesthetically unpleasing and/or have reduced cushioning properties. In the case of failure of the chambers 106, the resulting package may be rendered unsuitable for protecting and/or shipping an object.

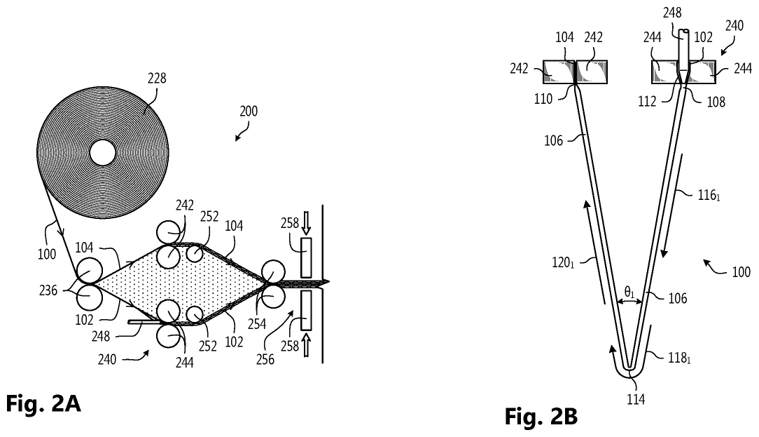

The issues with inflation of the web material 100 in the folded configuration shown in FIGS. 1B and 10 can be improved by holding the first and second longitudinal edges 102 and 104 apart where the chambers 106 are inflated. One example of holding the web material 100 is shown in FIGS. 2A and 2B. FIG. 2A depicts a top view of a portion of an embodiment of an automated packaging station 200. FIG. 2B depicts a cross-sectional view of the web material 100 as it is held by the automated packaging station 200 for inflation and sealing of the chambers 106.

The automated packaging station 200 includes a supply 228 of the web material 100. In the depicted embodiment, the supply 228 is in the form of a roll with the web material 100 wound around a core. The supply 228 is arranged such that the axis of the roll is substantially vertical. While on the supply, the chambers 106 of the web material 100 are in a non-inflated state such that the web material 100 is in a “flat” condition on the supply 228 and can be wound tightly on the roll. In some embodiments, the supply 228 is located on a substantially vertical spindle that is configured to rotate freely such that the web material 100 unwinds from the supply 228 as the web material 100 is pulled from the supply 228. In other embodiments, the supply 228 can be powered to actively unwind the web material 100 from the supply 228.

The automated packaging station 200 includes rollers 236. As can be seen in FIG. 2A, the web material 100 can be fed from the supply 228 to the rollers 236. The first and second longitudinal edges 102 and 104 of the web material 100 pass through the rollers 236. In some embodiments, the rollers 236 are counterrotating driving rollers that rotate to advance web material 100 from the supply. In some embodiments, the rollers 236 are communicatively coupled to a computing device so that the computing device can control the movements of the rollers 236 to thereby control the feeding of the web material 100 from the supply 228. In other embodiments, the rollers 236 can be passive rollers through which the longitudinal edges of the web material 100 pass, but that rotate passively as the web material 100 is moved by another element.

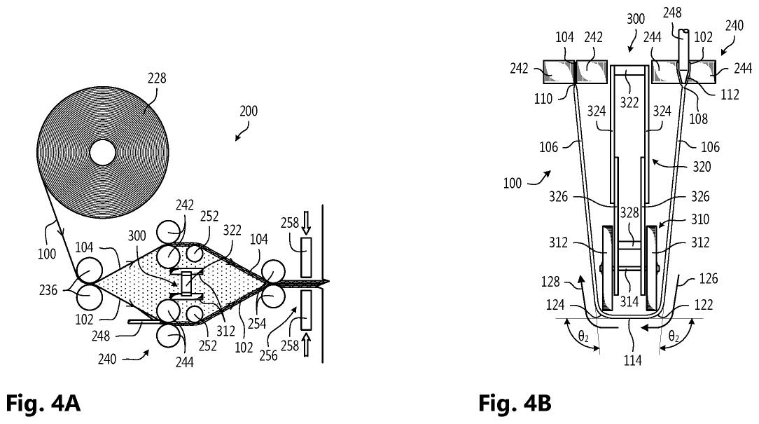

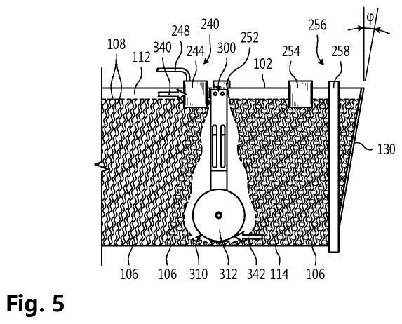

In the depicted embodiment, the automated packaging station 200 includes an inflation and sealing system 240 and rollers 242. The inflation and sealing system 240 includes rollers 244. The rollers 242 form a nip therebetween and the rollers 244 form a nip therebetween so that one longitudinal edge of the web material 100 passes through the rollers 242 and the other longitudinal edge of the web material 100 passes through the rollers 244. As can be seen in FIG. 4A, the first and second longitudinal edges 102 and 104 of the web material 100 diverge after passing through the rollers 236 as the first longitudinal edge 102 travels toward the rollers 244 and the second longitudinal edge travels toward the rollers 242. The divergence of the first and second longitudinal edges 102 and 104 of the web material 100 tends to reduce the severity of the longitudinal fold 114 in the web material 100 so that the longitudinal fold 114 does not have a sharply-creased fold, but the cross-section of the web material 100 at the rollers 242 and 244 tends to have the shape of a “V” (e.g., see FIG. 2B).

The inflation and sealing system 240 includes an inflation nozzle 248. The inflation nozzle 248 is configured to direct gas (e.g., air) into the web material 100. More specifically, the end of the inflation nozzle 248—the end out of which gas is directed—is located in the common channel 112 on the first longitudinal side 102 of the web material 100. Gas is directed out of the inflation nozzle 248, through the common channel 112, and through the ports 108 into the chambers 106 to cause inflation of the chambers 106. Once the chambers 106 are inflated, the cells form three-dimensional shapes (sometimes referred to as “bubbles”) along the inflated chambers 106. With the common channel 112 open, the two sheets of the common channel 112 pass on either side of an inflation nozzle 248 without being cut, as shown in FIG. 2B.

In the depicted embodiment, the rollers 244 are configured to form a longitudinal seal in the web material 100 after inflation of the chambers 106. In the depicted embodiment, the rollers 244 form a longitudinal seal to individually close the ports 108 of the chambers 106 of the web material 100. In some embodiments, one of the rollers 244 includes a circumferential heating element that contacts the web material 100 as it passes between the rollers 244 to form a heat seal in the web material 100. In other embodiments, the inflation and sealing system 240 may include a drag sealer or any other form of sealer to form the longitudinal seals. In other embodiments, the ends of the chambers 106 may include one-way seals that allow gas to enter the chambers 106 and hold the gas within the chambers 106 without the need of additional heat seals.

In the depicted embodiment, after the first and second longitudinal edges 102 and 104 of the web material 100 pass through the rollers 242 and through the inflation and sealing system 240, the path of the web material 100 is defined by rollers 252 and rollers 254. In some embodiments, the rollers 252 are idler rollers that passively rotate as the web material 100 moves. The rollers 254 are positioned such that the first and second longitudinal edges 102 and 104 of the web material 100 are brought back together after the chambers 106 are inflated. Both of the first and second longitudinal edges 102 and 104 pass between the rollers 254. In some embodiments, the rollers 254 are driving rollers that cause the web material 100 to move.

Downstream of the rollers 254 is a seal and cutting system 256. In the depicted embodiment, the seal and cutting system 256 includes jaws 258 that extend vertically from above the longitudinal edges of the web material 100 to below the longitudinal fold of the web material 100. At the instance depicted in FIG. 2A, the jaws 258 are withdrawn from the web material 100 to permit the web material 100 to be fed. The jaws 258 can periodically be brought together against the web material 100 (as indicated by the arrows outside of the jaws 258). In some embodiments, the jaws 258 include heating elements configured to form a trailing transverse seal, a transverse line of weakness, and a leading transverse seal when the jaws 258 are brought together against the web material 100. The trailing transverse seal closes a side of one of the pouches, the transverse line of weakness forms a break between the one of the pouches and a subsequent one of the pouches, and the leading transverse seal closes a side of the subsequent one of the pouches.

As can be seen in FIGS. 2A and 2B, the rollers 242 and 244 hold the first and second longitudinal edges 102 and 104, respectively, apart from each other. This causes the web material 100 to be held so that the cross-section of the web material 100 near the inflation and sealing system 240 is substantially V-shaped. In the depicted embodiment, the portion of the chambers 106 on one side of the longitudinal fold 114 and the portion of the chambers 106 on the other side of the longitudinal fold 114 are at an angle θ₁ with respect to each other. The angle θ₁ is greater than 0° such that the portion of the chambers 106 on one side of the longitudinal fold 114 is not parallel to the portion of the chambers 106 on the other side of the longitudinal fold 114.

To inflate the chambers 106, the inflation nozzle 248 can insert gas into the common channel 112 so that the gas passes through the ports 108 and into the chambers 106 in a substantially linear direction indicated by an arrow 116₁. As some of the gas reaches the longitudinal fold 114, the gas passes in the direction indicated by the arrow 116₁, then around the longitudinal fold 114 as indicated by an arrow 118₁, and then continues through the chambers 106 toward the distal ends 110 in a direction indicated by the arrow 120₁. The gas may fill both the portions of the chambers 106 between the longitudinal fold 114 and the distal ends 110 and the portions of the between the longitudinal fold 114 and the ports 108.

When the web material 100 is in the orientation shown in FIG. 2B, the longitudinal fold 114 may not completely close off the chambers 106 at the longitudinal fold 114. This may allow at least some gas to pass through the chambers 106 at the longitudinal fold 114. In some embodiments, the orientation of the longitudinal fold 114 may permit each of the chambers 106 to permit sufficient gas to pass by the longitudinal fold 114 during the time that each of the chambers 106 is exposed to the gas from the inflation nozzle 248 to fully inflate the chambers 106. In addition, the forces imparted by the gas as it changes directions from the direction indicated by the arrow 116₁ to the direction indicated by the arrow 120₁ may not be sufficient to cause deformity or failure of the walls of the chambers 106 near the longitudinal fold 114. However, in some embodiments, the rollers 242 and 244 may not be able to be positioned far enough apart so that the angle θ₁ is large enough to permit sufficient gas to pass by the longitudinal fold 114 during the time that each of the chambers 106 is exposed to the gas from the inflation nozzle 248 to fully inflate the chambers 106.

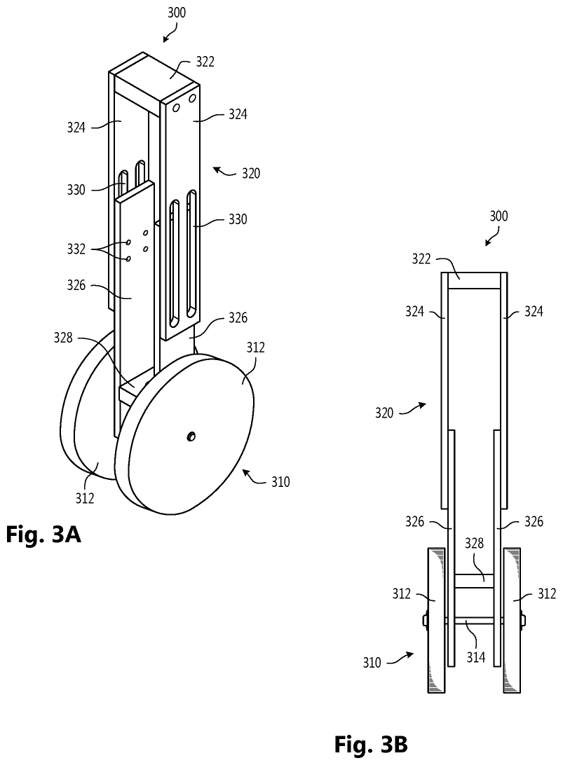

Depicted in FIGS. 3A and 3B are perspective and front views, respectively, of an embodiment of a guide 300 that can be positioned inside of the web material 100 to improve inflatability of the web material 100. The guide 300 includes a guide mechanism 310 that is supported by a guide structure 320. The guide mechanism 310 is configured to at least partially unfold a folded web material to improve the inflatability of inflatable chambers in the web material. In some embodiments, as is discussed below with respect to FIGS. 4A and 4B, the guide mechanism 310 is configured to bias a folded web from having a V-shaped cross-section to having a U-shaped cross-section. The guide structure 320 is configured to support the guide mechanism 310 at a particular location between sides of the folded web material.

In the depicted embodiment, the guide mechanism 310 includes rollers 312 that are coupled via a spindle 314. The spindle 314 is aligned substantially axially with each of the rollers 312 so that rotation of the spindle 314 causes rotation of the rollers 312 and rotation of one of the rollers 312 causes rotation of the spindle 314. While the depicted embodiment of the guide mechanism 310 includes two rollers, it will be understood that other embodiments of the guide mechanism 310 can include a different number of rollers. In other embodiments, the rollers 312 of the guide mechanism 310 can be replaced or supplemented by at least one of one or more belts, one or more slider mechanisms, one or more bearings, one or more continuous tracks, and the like.

In the depicted embodiment, the guide structure 320 includes an upper cross piece 322 that is coupled to upper leg segments 324. The upper cross piece 322 spans a distance between upper leg segments 324 so that the upper leg segments 324 are held apart from each other. The guide structure 320 also includes lower leg segments 326 that are coupled to a lower cross piece 328. The lower cross piece 328 spans a distance between the lower leg segments 326 so that the lower leg segments 326 are held apart from each other. The guide mechanism 310 is coupled to the lower leg segments 326. In the depicted embodiment, the spindle 314 of the guide mechanism 310 passes through the lower leg segments 326. The spindle 314 is configured to rotate with respect to the lower leg segments 326 so that the rollers 312 are capable of rotating with respect to the lower leg segments 326.

The upper leg segments 324 and the lower leg segments 326 are coupled to each other so that the guide mechanism 310 is held at a particular location. In the depicted embodiment, the upper leg segments 324 and the lower leg segments 326 are configured to be coupled in a range of respective positions so that the guide mechanism 310 can be held at a number of different locations with respect to the end of the guide structure 320 that includes upper cross piece 322. The upper leg segments 324 include slots 330 and the lower leg segments 326 includes holes 332, and individual fasteners (e.g., machine screws) can be passed through one of the slots 330 and one of the holes 332 to couple the upper leg segments 324 to the lower leg segments 326. The fasteners can be loosened to adjust the respective positions of the upper leg segments 324 and the lower leg segments 326 and then tightened to fix the respective positions of the upper leg segments 324 and the lower leg segments 326. The ability to quickly and easily adjust the position of the guide mechanism 310 with respect to the upper cross piece 322 allows the guide 300 to be used with a variety of sizes of folded web materials.

As noted above, the guide 300 can be configured to bias a folded web from having a V-shaped cross-section to having a U-shaped cross-section as shown in one embodiment depicted in FIGS. 4A and 4B. FIG. 4A depicts a top view of a portion of the automated packaging station 200 and the guide 300. FIG. 4B depicts a cross-sectional view of the web material 100 as it is held by the automated packaging station 200 and the guide 300 for inflation and sealing of the chambers 106. As can be seen, the guide 300 is positioned so that the guide mechanism 310 is located between portions of the web material 100. The rollers 312 are positioned so that the rollers 312 contact inner portions of the web material 100.

As the web material 100 travels between the supply 228 and the rollers 236, the web material 100 is in a folded configuration. For example, as the web material 100 travels between the supply 228 and the rollers 236, the cross-section of the web material 100 is similar to the cross-section shown in FIG. 10 where the longitudinal fold 114 may form a crease to block air passage through the chambers 106. After the web material 100 passes through the rollers 236 and the first and second longitudinal edges 102 and 104 are separated from each other, the natural tendency of the web material 100 may be to form a V-shaped cross-section, such as in the example shown in FIG. 2B. However, as noted above, the rollers 242 and 244 may not be able to be positioned far enough apart in some embodiments so that the angle θ₁ is large enough to permit sufficient gas to pass by the longitudinal fold 114 during the time that each of the chambers 106 is exposed to the gas from the inflation nozzle 248 to fully inflate the chambers 106. To avoid underinflation of the chambers 106, the guide 300 is configured to improve inflatability of the web material 100.

In the depicted embodiment, as can be seen in FIG. 4B, the guide 300 can be positioned so that the guide mechanism 310 is configured to unfold the longitudinal fold 114 so that the web material 100 has a U-shaped cross-section. When the longitudinal fold 114 unfolded, the longitudinal fold 144 does not pose a significant hinderance to the passage of gas through the chambers 106. In the context of unfolding the longitudinal fold 114, it will be noted that unfolding the longitudinal fold does not require making the web material perfectly straight where the longitudinal fold 114 had been. Rather, unfolding the longitudinal fold can refer to merely biasing the longitudinal fold 114 away from a creased orientation.

In the depicted embodiment, the web material 100 tends to bend around the rollers 312 to form bends 122 and 124 in the web material 100. While a bend in the web material 100 may form a crease in the web material 100 to prevent the flow of gas through the chambers 106, the bends 122 and 124 around the rollers 312 are at angles 82 that are sufficiently large to not pose a significant hinderance to the passage of gas through the chambers 106. For example, both of the directions indicated by the arrows 126 and 128 are significantly less extreme turns than the direction around the longitudinal fold 114 as indicated by the arrow 118₁ in FIG. 2B. In the depicted embodiment, the angles 82 are obtuse angles. A bend at an obtuse angle (e.g., one of the bends 122 and 124 at the angle θ₂ in FIG. 4B) may allow sufficiently more gas to pass than a fold that has been somewhat opened to an acute angle (e.g., the longitudinal fold 114 at the angle θ₁ in FIG. 2B). With the bends 122 and 124 in the web material 100, gas inserted into the chambers 106 by the inflation nozzle 248 passes toward the bend 122, around the bend 122 in the direction indicated by arrow 126, around the bend 124 in the direction indicated by arrow 128, and then continues to the distal ends 110.

In addition to the guide 300 opening the web material 100 to a U-shaped cross-section, the guide 300 can be located with respect to the inflation and sealing system 240 where the guide 300 is less likely to hinder inflation of the chambers 106. In the depicted embodiment, the guide 300 is positioned downstream of the inflation nozzle 248 and the rollers 242 and 244. With this positioning, the web material 100 is not in contact with the guide mechanism 310 when the chambers 106 are inflated. However, because the guide mechanism 310 is in contact with the web material 100 shortly downstream from the inflation nozzle 248 and the rollers 242 and 244, the guide mechanism 310 causes the web material 100 to have a U-shaped cross-section at the point where the inflation nozzle 248 inflates the chambers 106. Thus, the chambers 106 are more likely to inflate properly because the guide mechanism 310 causes the web material 100 has a U-shaped cross-section while not being in contact with the guide mechanism 310 at the point where the chambers 106 are inflated by the inflation nozzle 248.

In some embodiments, the guide 300 is held in place by structure of the automated packaging station 200 that is not depicted in FIGS. 4A and 4B. In some embodiments, the upper cross piece 322 is secured in a fixed position with respect to structure of the automated packaging station 200. In some embodiments, the upper cross piece 322 is coupled to the rollers 242 and 244 via structure of the automated packaging station 200 that fixes the respective positions of the upper cross piece 322 and the rollers 242 and 244. While the upper cross piece 322 may be coupled to the automated packaging station 200 so that the location of the upper cross piece 322 is fixed with respect to the automated packaging station 200, it will be apparent that the position of the guide mechanism 310 with respect to the upper cross piece 322 may be adjusted. For example, fasteners that pass through the slots 330 and the holes 332 may be loosened to permit adjustment of the location of the guide mechanism 310 with respect to the upper cross piece 322 and then tightened to fix the location of the guide mechanism 310 with respect to the upper cross piece 322.

In the embodiment shown in FIGS. 4A and 4B, the rollers 312 are idle rollers that are not driven. As the web material 100 is advanced, the rollers 312 rotate from the contact with the web material 100 as the web material 100 moves. In certain embodiments, the idler rollers may allow for proper inflation of the chambers and feeding of the web material 100. However, in other embodiments, the use of idle rollers may not provide for proper feeding of the web material 100. Depicted in FIG. 5 is a side view of an example of improper feeding of the web material 100 that can result from the use of the guide 300. In FIG. 5, a portion of the web material 100 has been omitted from the view to show the guide 300.

In FIG. 5, the rollers 244 are driven to advance the web material 100. Other rollers, such as rollers 254, may also be driven to advance the web material 100. The rotation of the rollers 244 imparts a force 340 on the web material 100 in the downstream direction near the common channel 112 to advance the web material 100. The guide 300 is positioned so that the guide mechanism 310 contacts the web material 100 near the longitudinal fold 114. Because the rollers 312 are idle rollers, the friction between the rollers 312 and the web material 100 imparts a force 342 in the upstream direction near the longitudinal fold 114. With the forces 340 and 342 acting in substantially opposite directions at the top and bottom of the web material 100, the forces 340 and 342 can cause the web material 100 to skew. In the depicted example, after the jaws 258 formed a leading end 130 of the web material 100, the web material 100 was advanced by the rollers 244 but the friction with the rollers 312 caused the web material 100 to be askew. More specifically, the leading end 130 of the web material 100 would typically be perpendicular to the direction of travel of the web material 100, however, the leading end 130 of the web material 100 is at an angle φ with respect to the typical orientation of the leading end 130. If the jaws 258 were to cut the web material 100 again while it was askew, the resulting package formed from the web material 100 would have the shape of an acute trapezoid or a right trapezoid instead of having the shape of a rectangle.

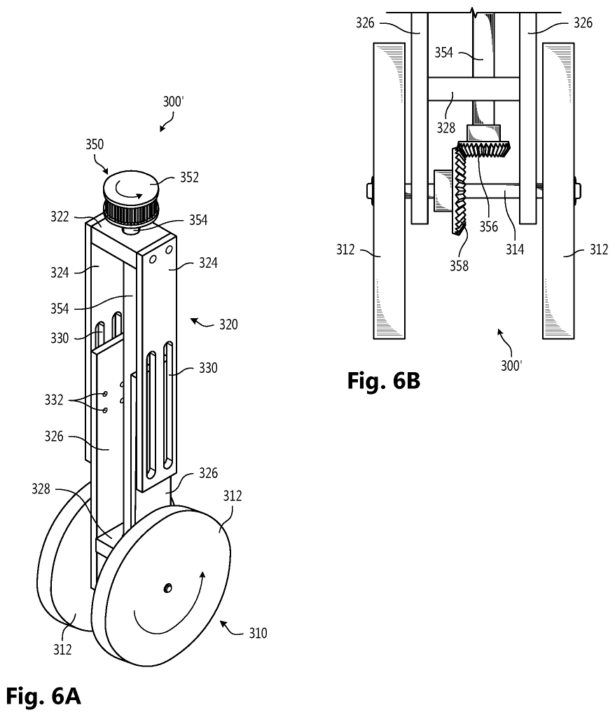

In some embodiments, the problem of web material skewing can be addressed using a driven guide. Depicted in FIGS. 6A and 6B are perspective and partial front views, respectively, of an embodiment of a driven guide 300′ that can be positioned inside of the web material 100 to improve inflatability of the web material 100 while avoiding skewing of the web material 100. The driven guide 300′ includes components that are similar to the components of the guide 300, such as the guide mechanism 310 and the guide structure 320. The driven guide 300′ also includes a power transmission system 350. In the depicted embodiment, the power transmission system 350 is a mechanical power transmission system configured to couple a driving force above the upper cross piece 322 to the rollers 312 in order to drive the roller 312.

In the depicted embodiment, the power transmission system 350 includes a gear 352 located above the upper cross piece 322. The gear 352 is configured to rotate about an axis that is substantially perpendicular to the top of the upper cross piece 322. In some embodiments, the gear 352 is one of a spur gear configured to be driven by another spur gear or by a chain, a worm wheel configured to be driven by a threaded worm, a pinion configured to be driven by a linearly-moving rack, a toothless gear (e.g., a pulley), or any other rotating gear that can be driven. The gear 352 is coupled to the end of a driveshaft 354 such that rotation of the gear 352 causes a corresponding rotation of the driveshaft 354. The driveshaft 354 passes through bores in the upper cross piece 322 and the lower cross piece 328. The end of the driveshaft 354 opposite the gear 352 includes a bevel gear 356. The bevel gear 356 is configured to engage a bevel gear 358 that is coupled to the spindle 314 of the guide mechanism 310. The bevel gear 356 engages the bevel gear 358 so that rotation of the bevel gear 356 by the driveshaft 354 causes rotation of the bevel gear 358. The bevel gear 358 is coupled to the spindle 314 such that rotation of the bevel gear 358 causes rotation of the spindle 314, which causes the rollers 312 to rotate. In this arrangement, the gear 352 can be driven to cause the rollers 312 to rotate.

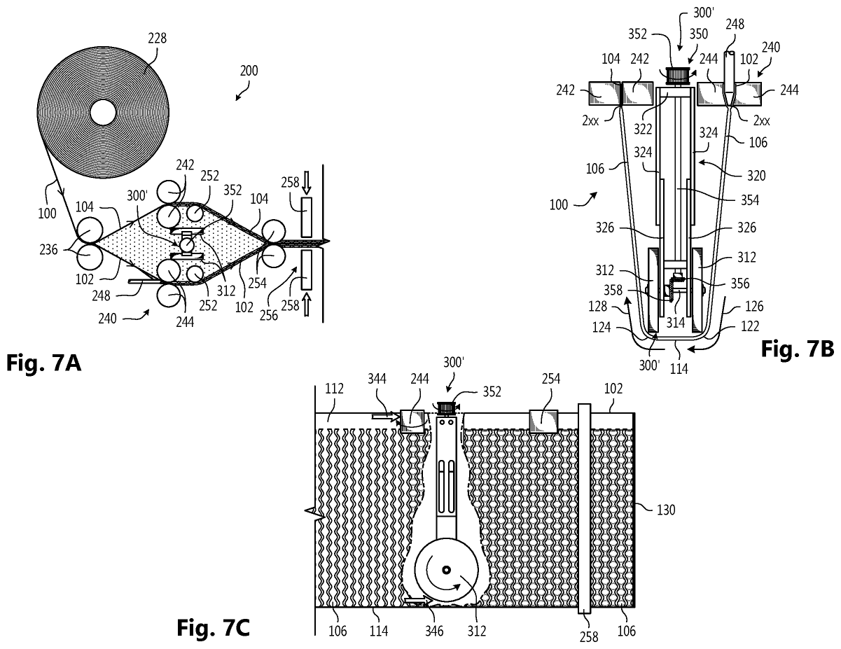

The driven guide 300′ can be configured to bias a folded web from having a V-shaped cross-section to having a U-shaped cross-section as shown in one embodiment depicted in FIGS. 7A to 7C. FIG. 7A depicts a top view of a portion of the automated packaging station 200 and the driven guide 300′. FIG. 7B depicts a cross-sectional view of the web material 100 as it is held by the automated packaging station 200 and the driven guide 300′ for inflation and sealing of the chambers 106. Depicted in FIG. 7C is a side view of an example of proper feeding of the web material 100 that can result from the use of the driven guide 300′. In FIG. 7C, a portion of the web material 100 has been omitted from the view to show the driven guide 300′.

In FIG. 7C, the rollers 244 are driven to advance the web material 100. Other rollers, such as rollers 254, may also be driven to advance the web material 100. The rotation of the rollers 244 imparts a force 344 on the web material 100 in the downstream direction near the common channel 112 to advance the web material 100. The driven guide 300′ is positioned so that the guide mechanism 310 contacts the web material 100 near the longitudinal fold 114. Because the rollers 312 are driven by the power transmission system 350, the rollers 312 rotate and impart a force 346 to the web material 100 in the downstream direction near the longitudinal fold 114. With the forces 344 and 346 acting in substantially the same downstream direction, the forces 344 and 346 may not cause the web material 100 to skew as it is advanced. In the depicted example, after the jaws 258 formed the leading end 130 of the web material 100, the web material 100 was advanced by the rollers 244 and the rollers 312 and caused the web material 100 to advance without being skewed. More specifically, the leading end 130 of the web material 100 remains substantially perpendicular to the direction of travel of the web material 100. By keeping the web material 100 from becoming skewed, the packages resulting from cuts by the jaws 258 would having a shape that is substantially rectangular. It will be understood that, in other embodiments, another form of the guide mechanism 310, such as a continuous track, could impart the force 346 to the web material 100 just as the rollers 312 impart the force 346 in the depicted embodiment.

The location of the gear 352 above the upper cross piece 322 can allow for access to the gear 352 may receive power. In the depicted embodiment, at least a portion of the gear 352 is positioned outside of the web material 100. In this way, a component that drives the gear 352 (e.g., a spur gear, a chain, a threaded worm, a linearly-moving rack, etc.) can be located outside of the web material 100, while causing the rollers 312 that are between portions of the web material 100 to rotate. This arrangement significantly reduces the chance that a component that drives the gear 352 will interfere with the proper feeding of the web material 100.

In some embodiments, the power transmission system 350 is coupled to a driving force (e.g., a motor) that also drives rollers in the automated packaging station 200 that move the web material 100 (e.g., rollers 242 and 244). Using the same driving force to drive both the rollers in the automated packaging station 200 that move the web material 100 and the power transmission system 350 can ensure that the guide mechanism 310 applies the force 346 at substantially any time that the rollers 244 apply the force 344. In some embodiments, the power transmission system 350 is configured such that the forces 344 and 346 have substantially the same magnitude and/or the forces 344 and 346 move the web material 100 at substantially the same speeds. For example, the gear ratio of the gear 352 and the component that drives the gear 352 and/or the gear ratio of the bevel gear 356 and the bevel gear 358 is selected so that the rollers 312 move the web material 100 near the longitudinal fold 114 at a substantially similar speed that the rollers 244 move the web material 100 near the common channel 112.

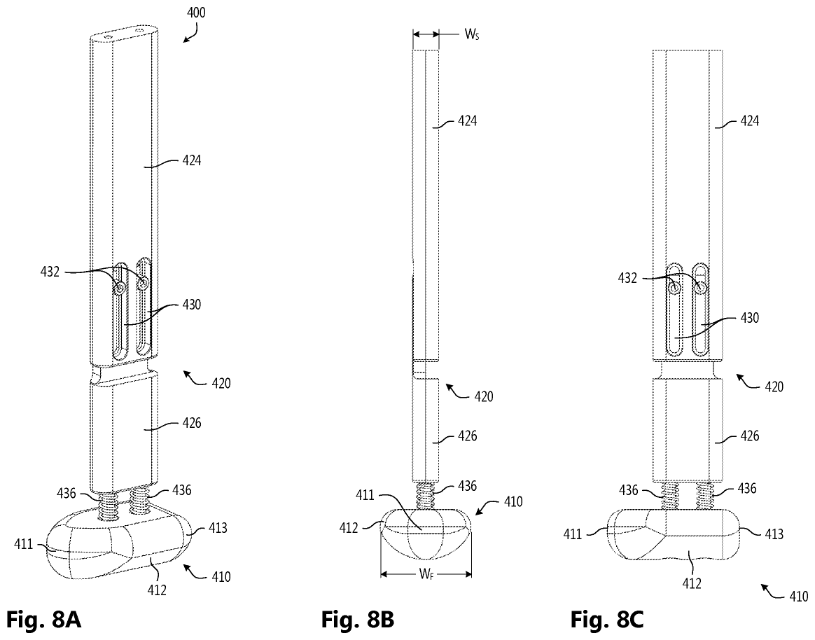

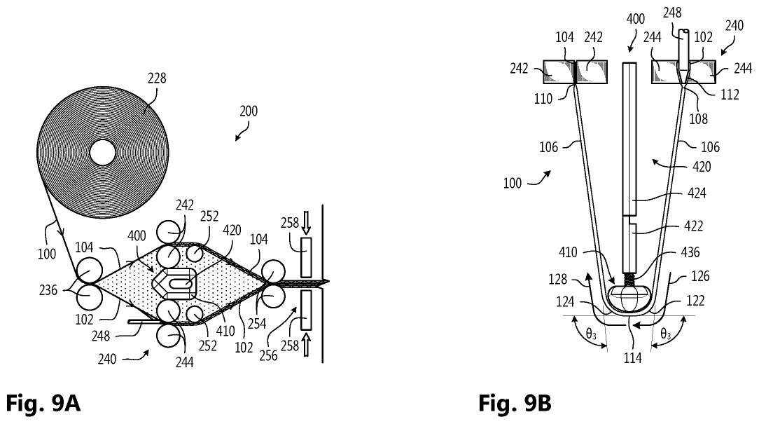

Embodiments of guide described above include rollers, including rollers that rotate freely and rollers that are driven. In other embodiments, static guides can be used to bias a folded web from having a V-shaped cross-section to having a U-shaped cross-section. FIGS. 8A, 8B, and 8C depict perspective, front, and side views, respectively, of an embodiment of a static guide 400 that can be positioned inside of the web material 100 to improve inflatability of the web material 100. The static guide 400 includes a static guide mechanism 410 that is supported by a guide structure 420. The static guide mechanism 410 is configured to at least partially unfold a folded web material to improve the inflatability of inflatable chambers in the web material. In some embodiments, as is discussed below with respect to FIGS. 9A and 9B, the static guide mechanism 410 is configured to bias a folded web from having a V-shaped cross-section to having a U-shaped cross-section. The guide structure 420 is configured to support the static guide mechanism 410 at a particular location between sides of the folded web material.

In the depicted embodiment, the static guide mechanism 410 includes a foot 412. In the depicted embodiment, the foot 412 is a single piece that has a contoured shape. In particular, depicted embodiment of the foot 412 has a front end 411 and a back end 413 where the front end 411 is narrower than the back end 413. In addition, the foot 412 in the depicted embodiment is contoured from the front end 411 around all sides of the front end 411 (e.g., the left, right, top, and bottom sides of the front end 411).

In the depicted embodiment, the guide structure 420 includes an upper leg segment 424 and a lower leg segment 426. In some embodiments, the static guide mechanism 410 is coupled to the lower leg segments 426. In the depicted embodiment, the static guide mechanism 410 is coupled to the lower leg segments 426 via a biasing mechanism 436. In the depicted embodiment, the biasing mechanism 436 includes a pair of compression springs that permit the static guide mechanism 410 to move and deflect (or “float”) as a film is fed by the static guide mechanism 410. In other embodiments, the static guide mechanism 410 can be fixedly coupled to the lower leg segments 426 without any form of biasing mechanism.

The upper leg segment 424 and the lower leg segment 426 are coupled to each other so that the static guide mechanism 410 is held at a particular location. In the depicted embodiment, the upper leg segment 424 and the lower leg segment 426 are configured to be coupled in a range of respective positions so that the static guide mechanism 410 can be held at a number of different locations with respect to the guide structure 420. In the depicted embodiment, the upper leg segment 424 includes slots 430 and the lower leg segment 426 includes mounting holes configured to receive fasteners 432 (e.g., machine screws). Each of the fasteners 432 can pass through one of the slots 430 to couple the upper leg segment 424 to the lower leg segment 426. The fasteners can be loosened to adjust the respective positions of the upper leg segment 424 and the lower leg segment 426 and then tightened to fix the respective positions of the upper leg segment 424 and the lower leg segment 426. The ability to quickly and easily adjust the position of the static guide mechanism 410 with respect to the guide structure 420 allows the static guide 400 to be used with a variety of sizes of folded web materials.

As noted above, the static guide 400 can be configured to bias a folded web from having a V-shaped cross-section to having a U-shaped cross-section as shown in one embodiment depicted in FIGS. 9A and 9B. FIG. 9A depicts a top view of a portion of the automated packaging station 200 and the static guide 400. FIG. 4B depicts a cross-sectional view of the web material 100 as it is held by the automated packaging station 200 and the static guide 400 for inflation and sealing of the chambers 106. As can be seen, the static guide 400 is positioned so that the static guide mechanism 410 is located between portions of the web material 100. The foot 412 are positioned so that the foot 412 contact inner portions of the web material 100.

In the depicted embodiment, as can be seen in FIG. 4B, the static guide 400 can be positioned so that the static guide mechanism 410 is configured to unfold the longitudinal fold 114 so that the web material 100 has a U-shaped cross-section. When the longitudinal fold 114 unfolded, the longitudinal fold 144 does not pose a significant hinderance to the passage of gas through the chambers 106. In the context of unfolding the longitudinal fold 114, it will be noted that unfolding the longitudinal fold does not require making the web material perfectly straight where the longitudinal fold 114 had been. Rather, unfolding the longitudinal fold can refer to merely biasing the longitudinal fold 114 away from a creased orientation.

In the depicted embodiment, the web material 100 tends to bend around the foot 412 to form bends 122 and 124 in the web material 100. While a bend in the web material 100 may form a crease in the web material 100 to prevent the flow of gas through the chambers 106, the bends 122 and 124 around the foot 412 are at angles 83 that are sufficiently large to not pose a significant hinderance to the passage of gas through the chambers 106. For example, both of the directions indicated by the arrows 126 and 128 are significantly less extreme turns than the direction around the longitudinal fold 114 as indicated by the arrow 118₁ in FIG. 2B. In the depicted embodiment, the angles 83 are obtuse angles. A bend at an obtuse angle (e.g., one of the bends 122 and 124 at the angle θ₃ in FIG. 9B) may allow sufficiently more gas to pass than a fold that has been somewhat opened to an acute angle (e.g., the longitudinal fold 114 at the angle θ₁ in FIG. 2B). With the bends 122 and 124 in the web material 100, gas inserted into the chambers 106 by the inflation nozzle 248 passes toward the bend 122, around the bend 122 in the direction indicated by arrow 126, around the bend 124 in the direction indicated by arrow 128, and then continues to the distal ends 110.

In addition to the static guide 400 opening the web material 100 to a U-shaped cross-section, the static guide 400 can be located with respect to the inflation and sealing system 240 where the static guide 400 is less likely to hinder inflation of the chambers 106. In the depicted embodiment, the static guide 400 is positioned downstream of the inflation nozzle 248 and the rollers 242 and 244. With this positioning, the web material 100 is not in contact with the static guide mechanism 410 when the chambers 106 are inflated. However, because the static guide mechanism 410 is in contact with the web material 100 shortly downstream from the inflation nozzle 248 and the rollers 242 and 244, the static guide mechanism 410 causes the web material 100 to have a U-shaped cross-section at the point where the inflation nozzle 248 inflates the chambers 106. Thus, the chambers 106 are more likely to inflate properly because the static guide mechanism 410 causes the web material 100 has a U-shaped cross-section while not being in contact with the static guide mechanism 410 at the point where the chambers 106 are inflated by the inflation nozzle 248. Moreover, the static guide 400 is dimensioned such that a width w_{f} of the foot 412 is greater than a width wₛ of the guide structure 420. In this way, the web material 100 is unlikely to contact the guide structure 420 because of the width w_{f} of the foot 412 with respect to the width wₛ of the guide structure 420.

In some embodiments, the static guide 400 is held in place by structure of the automated packaging station 200 that is not depicted in FIGS. 4A and 4B. In some embodiments, the top of the guide support 420 is secured in a fixed position with respect to structure of the automated packaging station 200. It will be noted that, when the top of the guide support 420 (e.g., the upper leg segment 424) is fixedly secured to the structure of the automated packaging station 200, the position of the static guide mechanism 410 with respect to the structure of the automated packaging station 200 can be varied by moving the lower leg segment 426 with respect to the upper leg segment 424.

For purposes of this disclosure, terminology such as “upper,” “lower,” “vertical,” “horizontal,” “inwardly,” “outwardly,” “inner,” “outer,” “front,” “rear,” and the like, should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Unless stated otherwise, the terms “substantially,” “approximately,” and the like are used to mean within 5% of a target value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

What is claimed is:

1. A system comprising:
a supply of a web material, wherein the web material includes chambers that are in fluid communication with a common channel, and wherein the web material in the supply is folded about a longitudinal fold such that lengths of the chambers are folded;
an inflation and sealing system configured to inflate and seal the chambers as the web material is fed from the supply; and
a guide having a guide mechanism that is configured to be located between portions of the web material as the web material is being fed from the supply, wherein the guide mechanism is configured to at least partially unfold the longitudinal fold in the web material at a point in the system where the inflation and sealing system is configured to inflate the chambers.

2. The system of claim 1, wherein the guide mechanism includes rollers configured to contact the web material on either side of the longitudinal fold.

3. The system of claim 2, wherein the rollers are idle rollers configured to rotate from contact with the web material as the web material moves.

4. The system of claim 2, wherein the rollers are driven such that the rollers impart a force to the web material as the rollers rotate.

5. The system of claim 1, wherein the guide mechanism further comprises a guide structure configured to support the guide mechanism between sides of the folded web material.

6. The system of claim 5, wherein the guide structure includes a first end and a second end, wherein the guide mechanism is coupled to the second end, and wherein the guide mechanism is coupled to the guide structure such that the guide mechanism is configured to be located at one of a number of different locations with respect to the first end.

7. The system of claim 6, wherein:
the guide structure comprises upper leg segments and lower leg segments; and
the upper leg segments and the lower leg segments are coupled to each other so that the guide mechanism capable of being located at the number of different locations with respect to the first end.

8. The system of claim 5, wherein the guide further comprises a power transmission system configured to couple a driving force to the guide mechanism in order to drive the guide mechanism.

9. The system of claim 8, wherein:
the guide structure includes an upper cross piece and a lower cross piece;
the power transmission system includes a driveshaft that passes through the upper and lower cross pieces; and
the power transmission system includes a first gear coupled to a first end of the driveshaft above the upper cross piece and a second gear coupled to a second end of the driveshaft below the lower cross piece.

10. The system of claim 9, wherein:
the guide mechanism includes rollers coupled to a spindle;
the spindle includes a third gear configured to engage the second gear such that rotation of the first gear causes rotation of the driveshaft, the second gear, the third gear, the spindle, and the rollers.

11. The system of claim 10, wherein the guide is configured to be located in the system such that at least a portion of the first gear is located above the web material.

12. The system of claim 10, where the rollers are in contact with the web material so that rotation of the rollers imparts a force on the web material.

13. The system of claim 12, wherein the force imparted by the rollers has a substantially similar magnitude to a second force imparted on the web material by the inflation and sealing system.

14. The system of claim 13, wherein the power transmission system is coupled to a driving force that also drives the inflation and sealing system such that the rollers apply the force applied by the rollers at substantially any time that the inflation and sealing system applies the second force.

15. The system of claim 1, wherein the guide mechanism contacts the web material to cause the web material to have a U-shaped cross-section at the point in the system where the inflation and sealing system is configured to inflate the chambers.

16. The system of claim 15, wherein the guide is located in the system downstream of the inflation and sealing system such that the guide mechanism contacts the web material at a location other than the point in the system where the inflation and sealing system is configured to inflate the chambers.

17. The system of claim 1, wherein the guide is a static guide and the guide mechanism is a static guide mechanism.

18. The system of claim 17, wherein the static guide mechanism includes a foot that has a contoured shape.

19. The system of claim 18, wherein the foot has a front end and a back end, and wherein the front end is narrower than the back end.

20. The system of claim 17, wherein the guide further comprises a guide structure configured to support the guide mechanism between sides of the folded web material, and wherein the guide mechanism is coupled to the guide structure by a biasing mechanism.

21. A guide for use with an inflatable web material, wherein the web material includes chambers that are in fluid communication with a common channel, and wherein the web material in a supply of the web material is folded about a longitudinal fold such that lengths of the chambers are folded, the guide comprising:
a guide structure; and
a guide mechanism supported by the guide structure;
wherein the guide mechanism is configured to be located between portions of the web material as the web material is being fed from the supply;
wherein the guide mechanism is configured to at least partially unfold the longitudinal fold in the web material at a point where the inflation and sealing system is configured to inflate the chambers; and
wherein the guide mechanism is configured to contact the web material to cause the web material to have a U-shaped cross-section.

22. The guide of claim 21, wherein the guide is position able with respect to the inflation and sealing system to cause the web material to have the U-shaped cross-section at the point where the inflation and sealing system is configured to inflate the chambers.

23. The guide of claim 21, wherein the guide mechanism includes one or more of a belt, a slider mechanism, a bearing, or a continuous track.

24. The guide of claim 21, further comprising:
a power transmission system configured to couple a driving force to the guide mechanism in order to drive the guide mechanism.

25. The guide of claim 21, wherein the guide mechanism is a static guide mechanism.

26. The guide of claim 25, wherein the static guide mechanism includes a foot that has a contoured shape.

27. The guide of claim 21, wherein the guide mechanism is coupled to the guide structure by a biasing mechanism.
